(19) United States
(12) Patent Application Publication
(10) Pub. No.: US 2007/0165861 A1
(43) Pub. Date: Jul. 19, 2007

(54) Method and electronic terminal for rfid tag type encryption

(76) Inventors: Carmen Kuhl, Helsinki (FI); Markus Schetelig, Espoo (FI); Jens-Uwe Soehner, Dortmund (DE)

Correspondence Address: Hollingsworth and Funk, 8009 34th Avenue South, Suite 125, Minneapolis, MN, 55425, US

(21) Appl. No.: 10/572,716

(22) PCT Filed: Sep. 22, 2003
(86) PCT No.: PCT/IB03/04088

§ 371 Date: Nov. 22, 2006

(51) Int. Cl. H04K 1/00

(52) U.S. Cl. 380/270

(57) ABSTRACT

There is disclosed a method for identifying the type of an RFID tag, comprising the steps of receiving encrypted data from said RFID tag, decrypting said data by at least one decryption method, evaluating if said data has been correctly decrypted by said at least one decryption method, and in case said at least one decryption method has succeeded in decrypting said data, deriving a tag type from said decryption method. Further there is disclosed a device for identifying the type of an RFID tag, comprising a radio frequency identification tag reader for receiving data from a radio frequency identification tag, a decryptor for decrypting said data by at least one decryption method, the decryptor being suitable to evaluate if said data has been correctly decrypted by said at least one decryption method, and a data processing unit suitable to derive a tag type from said at least one decryption method and to generate a corresponding output. Also there is disclosed a device for identifying the type of an RFID tag, containing encrypted data, and comprising a transmitter for sending said data to a radio frequency identification tag reader, characterized in that said encrypted data contains an indication of the type of radio frequency identification tag.

The present invention relates to the identification of the type of an RFID tag. More specifically, it relates to the identification of an RFID tag—the type of which has been encrypted by encryption methods. More specifically the invention relates to methods for reading and identifying such tag types and electronic devices capable of reading and identifying these types.

“Radio frequency identification” (RFID) technology utilizes systems comprising a device containing data and another device being able to read and obtain these data. The data containing device is called an RFID tag, which can be attached to certain goods (e.g. containers), or be placed in certain areas like entrances and the like. Basically, RFID tags include an electronic circuit and a radio frequency (RF) interface and high frequency (HF) interface, respectively, which is coupled to an antenna and the electronic circuit. Two main classes of RFID tags can be distinguished, i.e. passive RFID tags which are activated by RFID tag readers which generate an interrogation signal, for example an RF signal at a certain frequency and active RFID tags which comprise own power supplies such as batteries or accumulators for energizing.

Passive inductive RFID tags are energized by passing through an energizing electromagnetic field, i.e. the interrogation signal. The RFID tags resonate at a frequency of the electromagnetic field that causes interference in the electromagnetic field, which can be detected and evaluated by the RFID tag reader.

Passive RFID tags reflect a small amount of the electromagnetic energy of an interrogation signal radiated by the RFID tag reader. The reflected signal can be modulated or encoded in any way to embed RFID tag information stored in the REID tag to be transmitted to the RFID tag reader. In detail, backscatter RFID tags receive the electromagnetic energy of the interrogation signal and convert a small amount of the electromagnetic energy for energizing the electronic components of the RFID tag. The active RFID tags may be polled for data transmission or may transmit in a self-controlled way.

The RFID tag reader device utilized to receive the data from the tag may be combined with any other form of device to further utilize the obtained data. Both the data itself and the further usage are specific to an application or service. Typical applications as of today include access control, item tracking, labelling of goods and the like.

Until now, such systems have been mainly used in closed systems. Existing RFID systems are usually dedicated to one specific usage only, e.g. for providing access to a building, tracking assets, immobilizing vehicles and the like. Consequently, RFID reader devices being part of such systems did not need the ability to distinguish between different types of application. Their use is commonly restricted to single proprietary applications; wherein RFID readers and RFID tags belonging to different applications are not interoperable in any way, e.g. the RFID tag that grants access to the building of an employer cannot be used to immobilize the persons vehicle. Or vice versa, the corresponding reader devices in the vehicle and in the entrance area of the building are not able to understand the data that is sent by the respective other tag. As the use of RFID tags is becoming more and more common, a certain level of interoperability is desired.

To achieve that, one crucial step in the communication between RFID tag and reader device is the recognition of the type of a tag by the reader device. For example three different types according to their usage could be regarded as public, private and subscribed. Public tags contain information that shall be accessible by every reader device, like a map of the city supplied by a tag in the town hall. Private kind of tags will be accessible only by a limited group of reader devices, which could apply for access control and the like. Subscribed type of tags provide information that shall only be visible to readers containing a sort of key, or other means of getting access, included in the reader device, e.g. additional information about exhibits in a museum for visitors who paid an extra fee for this service.

Current approaches for identifying tag types as promoted by vendors and standards organisations are utilizing UIDs (unique IDs) to identify an RFID tag. As the name suggests, such UIDs must be standardized and defined in a manner that every manufacturer, service provider, application and the like gets assigned its own, unique UID. For this purpose a database is needed to perform lookups of tag UIDs in order to associate it with a specific manufacturer, service provider etc. Considering mass market applications, such a mechanism would require an extremely large number of unique UIDs and the needed database would be hard, if not impossible, to maintain; considering its size, mandatory updating procedures and so on. This renders the use of UIDs in coordination with the needed databases unsuitable for mass market applications.

So, obviously there exists a need for identifying the type of a certain tag, or in other words to determine the group the tag belongs to (e.g. public, private and subscribed) in an improved way.

It is known that certain aspects concerning data security, i.e. the allowance to access the data, data integrity, i.e. the prevention of data contained in a tag being modified by unauthorized sources, and data validity, i.e. the assurance that data being retrieved from a tag originated by the claimed source only have been discussed hitherto.

The object of the present invention is to provide new and improved methods and devices suitable to determine the type of an RFID tag by an RFID tag reader device.

This object is achieved by providing methods and devices according to the appended claims.

According to an aspect of the present invention, a method for identifying the type of an RFID tag is provided. In an initial step, encrypted data is received from an RFID tag. The next step is to decrypt said data. For this purpose, at least one decryption method is utilized. The following step is to evaluate if the applied decryption method was actually successful. If one such decryption method succeeds in decrypting the received data, the tag type is derived from the successful method or algorithm.

It is preferred that in case said at least one decryption method has not succeeded in decrypting said data an unknown tag type is derived.

It is preferred that sending the data is caused by the RFID reader device through sending an interrogation signal to the RFID tag. With passive RFID tags, this is the usual way of accessing RFID tag data, since those do not have own power sources, but are energized through the RFID tag reader device. With active RFID tags containing own power supplies (being connected to a power line, a battery or the like), the interrogation signal may be used to trigger the tag to send data by itself Otherwise such tags would have to continuously send their data, or in regular intervals, because they would not know if a tag reader device was present and operative to read the contents of the tag. This may not be wanted, to reduce electromagnetic radiation. Or in a security application it may not be wanted for anyone to know that an RFID tag is present at all. In that case only authorized persons could activate the tag with a specific interrogation or trigger signal.

According to another aspect of the present invention, an electronic terminal is provided, comprising an RFID tag reader for receiving data from an RFID tag, a decryptor containing at least one decryption method to be executed and being suitable to apply said at least one decryption method to said received data in order to decrypt it, and a data processing unit suitable to derive the type of tag from said at least one decryption method and to generate a corresponding output. That means the decryptor contains and applies one up to a plurality of decryption methods or algorithms. These algorithms can be applied to the received data successively and the data processing unit is then able to derive the tag type from a decryption method, depending on which, if any, the decryption algorithm succeeds in decrypting the data.

According to another aspect of the present invention, an electronic terminal is provided comprising an RFID tag reader for receiving data from an RFID tag, a decryptor containing a decryption method and being suitable to apply said decryption method to said received data in order to decrypt it, and a data processing unit suitable to read out an indication of the tag type contained in the decrypted data and to generate a corresponding output.

It is preferred that the electronic terminal also contains a transmitter for for sending an interrogation signal to an RFID tag, the advantages of which have been discussed earlier.

It is preferred that the electronic terminal is a mobile terminal, i.e a mobile phone, a PDA or the like. The advantages of providing a mobile or portable terminals, compared to a terminal that is fixed for example to a building or vehicle, should be evident.

In another aspect of the invention there is provided a method for identifying the type of RFID tag which comprises in an initial step receiving encrypted data from the RFID tag, said data containing an indication of the type of tag. Then a decryption method is applied to the encrypted data and it is ensured to read out the indication of the tag type from the decrypted data.

The accompanying drawings are included to provide a further understanding of the invention and are incorporated in and constitute a part of this specification. The drawings illustrate embodiments of the present invention and serve, together with the description, to explain the principles of the invention.

In the drawings,

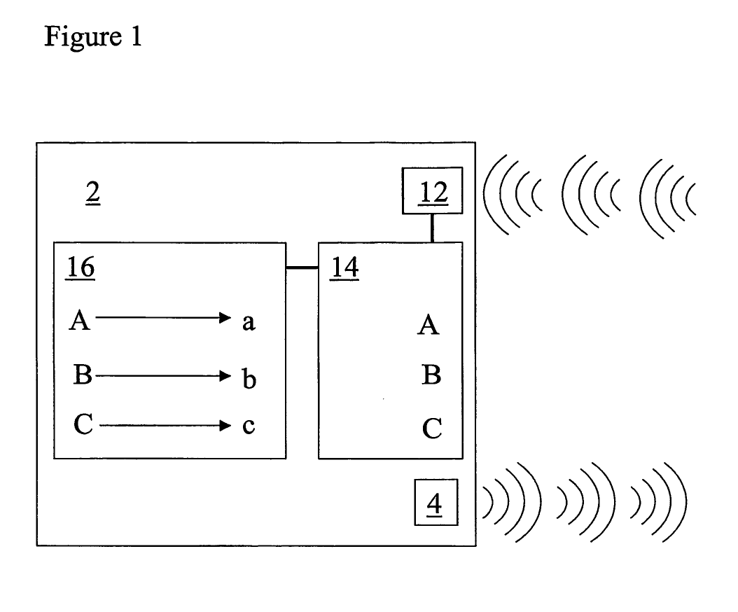

FIG. 1 shows an embodiment according to the present invention;

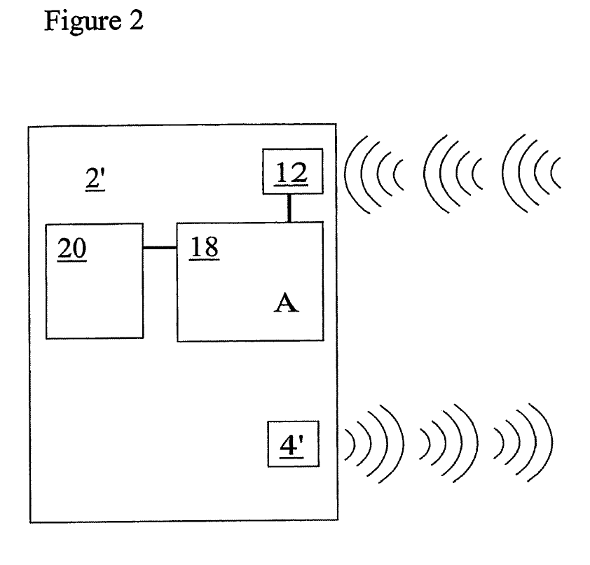

FIG. 2 shows another embodiment according to the present invention;

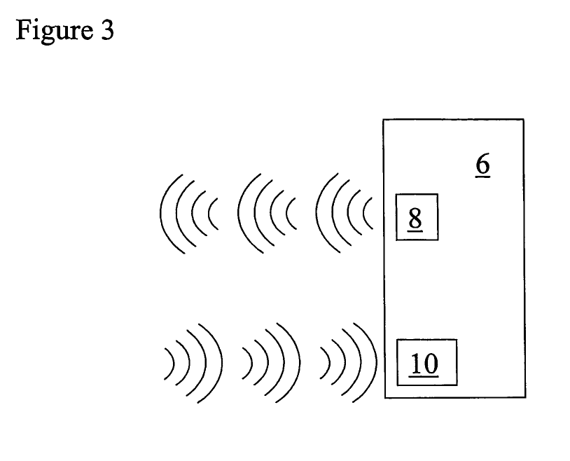

FIG. 3 shows yet another embodiment according to the present invention;

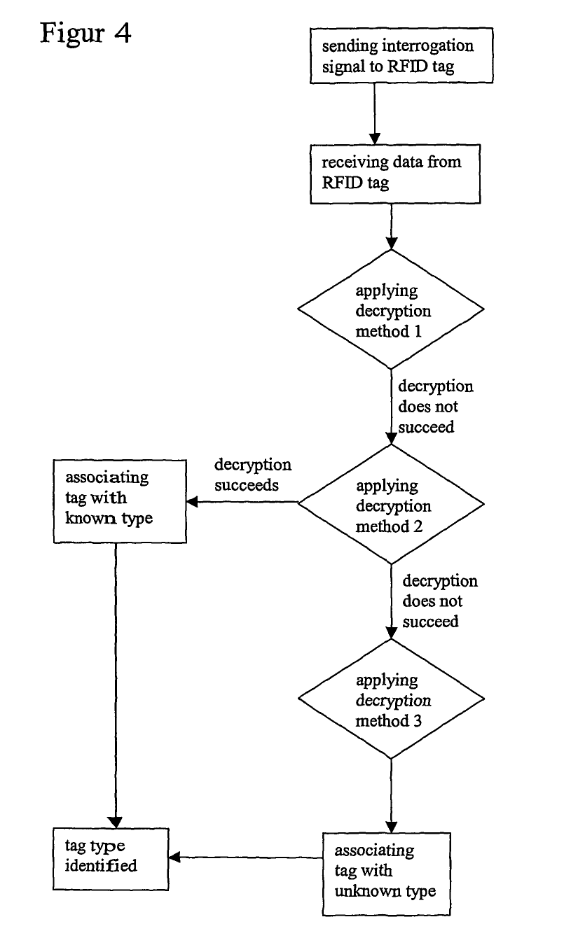

FIG. 4 is a schematic illustration of a method according to the present invention;

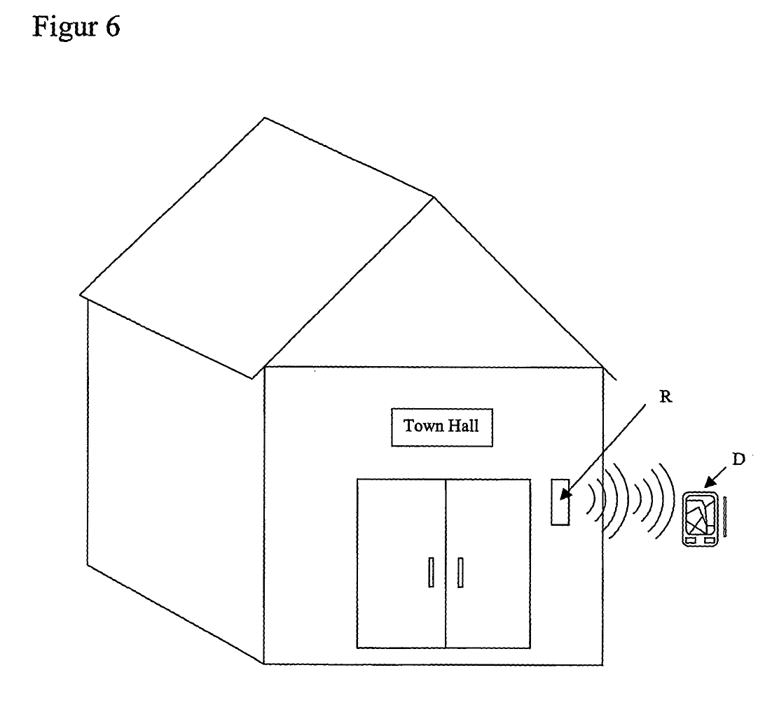

FIG. 6 shows an embodiment according to the present invention;

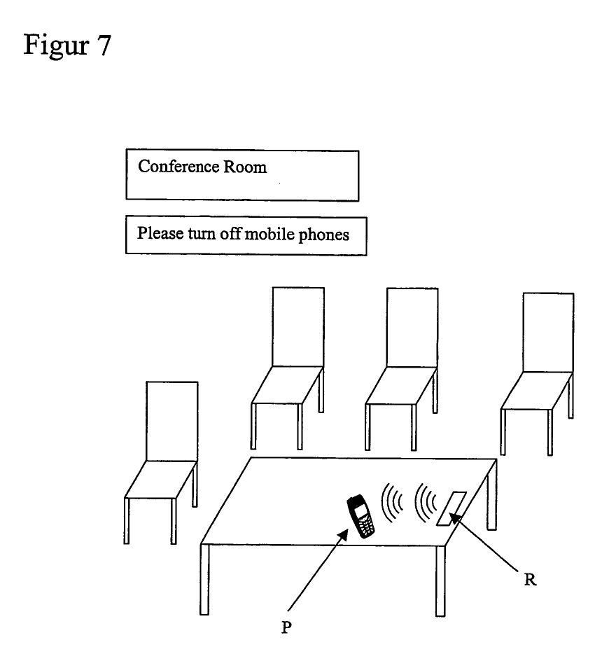

FIG. 7 shows another embodiment according to the present invention; and

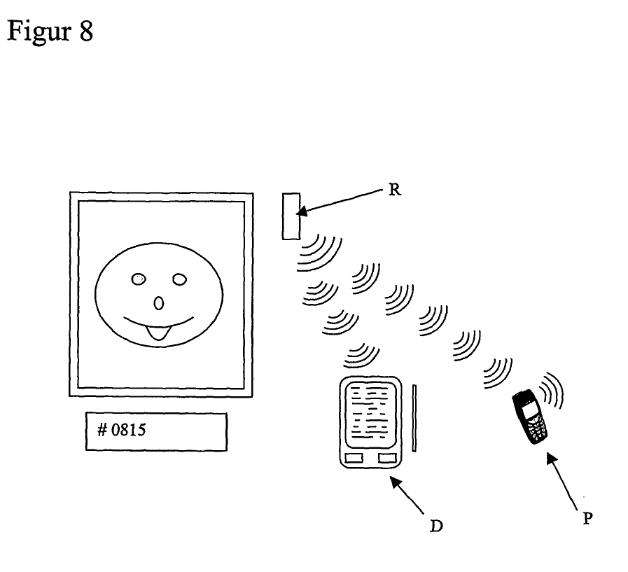

FIG. 8 shows yet another embodiment according to the present invention.

In FIG. 1, an electronic terminal 2, suitable to perform the identification of a tag type is schematically illustrated. The electronic terminal 2 comprises a transmitter 4 for sending an interrogation signal to an RFID tag. An RFID tag reader 12 is provided to receive data from an RFID tag. The transmitter 4 may be integrated into the RFID tag reader 12, using the same circuit that is used for receiving data. The transmitter 4 may either be operated by a user or controlled by the RFID tag reader 12. The incoming data is fed to a decryptor 14, which is loaded with at least one decryption method or code sections of a computer program destined for executing the corresponding algorithm. In FIG. 1 there are 3 decryption methods illustrated, referred to by letters A, B and C. Decryption methods A, B and C can be successively applied to the data by the decryptor 14, and the decryptor 14 can evaluate if an applied decryption method has correctly decrypted said encrypted data. The decryptor 14 is connected with a data processing unit 16, which contains a database for associating decryption methods A, B and C with a corresponding tag type, referred to as a, b and c. The data processing unit 16 can thereby derive the tag type from the decryption method used and generate a corresponding output.

In FIG. 2, an electronic terminal 2′ suitable to perform the identification of a tag type is schematically illustrated. The electronic terminal 2′ comprises a transmitter 4′ for sending an interrogation signal to an RFID tag. An RFID tag reader 12 is provided to receive data from an RFID tag. The transmitter 4 maybe integrated into the RFID tag reader 12, using the same circuit that is used for receiving data. The transmitter 4 may either be operated by a user or controlled by the RFID tag reader 12. The incoming data is fed to a decryptor 18, which contains a standardized decryption method or algorithm and is suitable to apply this algorithm to the encrypted data. In the data an indication of the tag type is included, which after decryption can be read by a processing unit 20, which serves to read out this indication and to generate a corresponding output. Processing unit 20 is therefore connected with the decryptor 18.

In FIG. 3, an RFID tag 6 is illustrated. The RFID tag 6 comprises a transmitter 8 for sending data The RFID tag 6 also comprises a receiver 10, which provides a possibility for the RFID tag 6 to receive interrogation signals. Receiving such an interrogation signal will cause the RFID tag 6 to send out the encrypted data contained in the RFID tag 6. It may be desirable to integrate receiver 10 and transmitter 8, in which case an integrated device may suit the purpose of sending data and receiving interrogation signals together. The RFID tag 6 may either be self-powered by some kind of power source (not shown), or it may be energized through said interrogation signal, whose energy could partly be used to power the RFID tag 6.

A possible operation of the electronic terminal 2 of FIG. 1 is illustrated in FIG. 4, and with regard to the electronic terminal 2 of FIG. 1 will be described as follows:

A user is utilizing the electronic terminal 2 to identify the type of an RFID tag yet unknown to him. An RFID reader device by sending an interrogation signal causes the RFID tag to send its data. Sending this signal may for example be operated by the user himself, the RFID tag reader device, or the electronic terminal comprising the reader. Also controlling this signal from some external device may be possible. The incoming encrypted data is received by the RFID tag reader 12. The data is fed into the decryptor 14, which is loaded with for example 3 decryption algorithms A, B and C, wherein A could be an “empty” algorithm, or in other words, an identity algorithm that leaves the incoming data unchanged. B and C can be “normal” algorithms that really process the incoming data while decrypting it. So the algorithms A, B and C are now successively applied to the encrypted data, until either one of them succeeds in actually decrypting the data, or until the last one used has not succeeded yet to decrypt the data. In an easy case, where the tag is of public type, i.e., that the data is not encrypted or in other words decrypted using the identity algorithm, algorithm A will succeed in “decrypting” the data. In other cases, either B or C may succeed, or none of the algorithms contained in the decryptor 14 might succeed at all. So either an indication of the successful algorithm is passed over to a data processing unit 16 over a line connecting it with the decryptor 14, or the indication that no algorithm was suitable to perform a decryption at all. The data processing unit 16 will now perform some kind of lookup in an internal database, which associates algorithms for decryption with types of tags. The easiest association would be that to an unknown type, in case the decryptor 14 was not able to find an algorithm suitable to actually decrypt the data and would have indicated this outcome to the data processing unit 16. This association is not shown in FIG. 1. In every other case, where either algorithm A, B or C was submitted from the decryptor 14, the data processing unit 16 will perform a lookup and make an association to either type a, b or c, which might stand for public, private and subscribed type for example. With this step, the identification of the tag type is completed; the type has been derived from the decryption method used. The way described here could be called an implicit identification of the tag type, regarding the process to determine the tag type.

In FIG. 6 a typical use of a tag belonging to the public group of tags is illustrated. If for example a tourist is visiting a certain town and wants to obtain more information about the town, he will probably visit a place like the town hall. In this case, an RFID tag R belonging to a public type can provide useful information like a map of the city, which the tourist can freely access. That is, because according to the public type of tag, the information contained in or provided by the tag is not encrypted, or in other words, encrypted with the identity algorithm. Another example might be to provide the hours of business of an office or the like to a citizen. This can be achieved by for example a mobile phone through the use of spoken information which can be reproduced or played back acoustically through the phones speaker. Or it can be visual information like a graphical city map, which can be accessed and displayed by devices comprising graphical displays or screens like PDAs D and the like.

In FIG. 7 a possible use of a tag of a private kind of type is illustrated. In a conference room one could install a tag R containing the information instructing any mobile phone P in range to switch to a non-acoustic or silent mode instead of a disturbing ring tone. This would be a convenient method to eliminate possible disturbances caused by phones P ringing in the middle of some meeting or conference if any mobile phone P is left to conventional acoustic ring tone on purpose or unintentionally. The use of such a kind of tag R could be restricted to a certain manufacturer, like Nokia® or its partner firms, in which case only Nokia® phones would be enabled to utilize the information contained in the tag. Phones from other manufacturers would not understand the instruction to shut down its acoustic ring tone if this is desired. It might though be desirable to provide the information in a way that not only Nokia® phones could understand and perform the instruction given through the data sent by the tag. It is possible to provide only information specific to devices from a certain manufacturer, like Nokia®, to provide at least part of the information accessible by all kinds of devices that are enabled to receive the data sent by the tag, in which case the instruction to switch to none-acoustic operation for example could be publicly accessible, while other information would be restricted to Nokia® phones. This could be additional information about the meeting/conference or the like.

In FIG. 8 a possible use of a type of tag for subscribed services is illustrated. Subscribing usually means that a person has to pay a certain amount of money to be given the key or other means for accessing the subscribed information. A possible use of such kind of information could be providing extra information about for example the exhibits in a museum. In that case any visitor would have the possibility to purchase a key or other means to access it. While any other visitor would be given only the “usual”, free information about the paintings for example, the subscribed user will be provided with extra information. This could be either acoustic, i.e. spoken information, that can be played back by devices like mobile phones P comprising a kind of speaker, or visual information to be displayed by devices comprising screens like PDAs or the like.

There are two possible methods for obtaining the data of an RFID tag. When using a passive RFID tag, the RFID tag reader is required to actively obtain the data. Passive tags are only energized by the reader device, so the activation signal, usually referred to as interrogation signal, is mandatory to receive the tag's data. The situation is different with active tags having an own power source. Such tags may send their data independently from interrogation signals. The interrogation signal may be used to activate, in other words trigger the tag to send data. In that case, operation would be substantially similar to that of passive RFID tags. For certain applications it may though be useful to control the sending of data externally, and not by the tag reader device. In such a case the RFID tag reader would not be required to send an interrogation signal first, but would just listen for incoming data. This applies specifically to RFID tags that send data by itself continously or in regular intervals.

A possible way to evaluate if a decryption was actually successful, i.e. that the encrypted data has been correctly decrypted, could be to include a keyword in the encrypted data. If a device performing a decryption would now read out this keyword from the decrypted data, this could signal the correct decryption. Other methods to evaluate if decryption was successful are possible, which are known to those skilled in the art.

There are at least two possible approaches for the identification of a tag type utilizing encryption. First it would be possible to associate a predetermined encryption mechanism or algorithm to every group of tag (like public, private and subscribed for example). By identifying the mechanism used to encrypt the data sent by a tag the tag reader device could derive the group the tag is belonging to. Identifying would then mean to use every algorithm known to the reader device until either decryption succeeds or none of the known algorithms succeeds. The latter would then result in identifying the tag as belonging to an unknown group, i.e. that the reader device has no access to this particular group, while otherwise the group the tag is belonging to corresponds directly with the algorithm that proved successful. This is a kind of straight forward approach and thus easy to implement. There are two major drawbacks of such a way of identification. Depending on the total number of groups, successively applying one decryption method after another to the received data in a “trial and error” scheme could take up considerable time and/or processing power. Also, the need for storing a database associating decryption algorithms with corresponding tag types makes it mandatory to provide storage means, making the circuit more complex and cost-intensive. This approach has the advantage to be easily scalable, additional types of tags can be added by using yet another corresponding encryption algorithm. While on the one hand this will not affect previous tag reader devices negatively, which is quite desirable, those devices will also not be aware of the new type of tag without upgrading, which on the other hand can be undesirable.

State of the art RFID tags and RFID reader devices restrict the use of encryption mechanisms to secure the contents of the tag, while the identification of a tag is handled by utilizing UIDs. Instead the present invention suggests the encryption mechanisms already used for data security in RFID applications to be used to identify the type of a tag. This eliminates the drawbacks of the use of UIDs for the mass market.

1. Method for identifying the type of an RFID tag, comprising the steps:
receiving encrypted data from said RFID tag;
decrypting said data by at least one decryption method;
evaluating if said data has been correctly decrypted by said at least one decryption method;
in case said at least one decryption method has succeeded in decrypting said data, deriving a tag type from said decryption method.

2. Method according to claim 1, wherein said encrypted data is requested by sending an interrogation signal.

3. Software tool comprising program code means stored on a computer readable medium for carrying out the method of anyone of the preceding claims when said software tool is run on a computer or network device.

4. Computer program product comprising program code means stored on a computer readable medium for carrying out the method of anyone of the preceding claims when said program product is run on a computer or network device.

5. Computer program product comprising program code, downloadable from a server for carrying out the method of anyone of the preceding claims when said program product is run on a computer or network device.

6. Computer data signal embodied in a carrier wave and representing a program that instructs a computer to perform the steps of the method of anyone of the preceding claims.

7. Electronic terminal (2), comprising a radio frequency identification tag reader (12) for receiving data from a radio frequency identification tag, a decryptor (14) for decrypting said data by at least one decryption method, the decryptor (14) being suitable to evaluate if said data has been correctly decrypted by said at least one decryption method, and a data processing unit (16) suitable to derive a tag type from said at least one decryption method and to generate a corresponding output.

8. Electronic terminal (2; 2′) according to claim 7, wherein said electronic terminal (2; 2′) also comprises a transmitter (4; 4′) for sending an interrogation signal to a radio frequency identification tag (6).

9. Electronic terminal (2; 2′) according to anyone of claims 7 to 8, wherein said electronic terminal (2; 2′) is a mobile terminal device.

10. Electronic terminal according to anyone of claims 7 to 9, wherein said electronic terminal is enabled to communicate via a public land mobile network.

11. Radio frequency identification tag (6), containing encrypted data, and comprising a transmitter (8) for sending said data to a radio frequency identification tag reader, characterized in that said encrypted data contains an indication of the type of radio frequency identification tag (6).

12. Radio frequency identification tag (6) according to claim 11, wherein said radio frequency identification tag (6) also comprises a receiver (10) for receiving interrogation signals from a radio frequency identification tag reader (12).
